(19) United States
(12) Patent Application Publication
(10) Pub. No.: US 2019/0080625 A1
(43) Pub. Date: Mar. 14, 2019

(54) AUTOMATED LEARNING MANAGEMENT SYSTEM

(71) Applicant: R. Kay Green, Woodbridge, VA (US)

(72) Inventor: R. Kay Green, Woodbridge, VA (US)

(21) Appl. No.: 16/033,167

(22) Filed: Jul. 11, 2018

Related U.S. Application Data
(60) Provisional application No. 62/530,881, filed on Jul. 11, 2017.

(51) Int. Cl. G09B 7/02; G09B 5/12

(52) U.S. Cl. CPC G09B 7/02; G09B 5/125

(57) ABSTRACT

An automated online classroom system includes a processor, a memory on which are stored machine readable instructions that when executed by the processor, cause the processor to obtain a first assignment and a corresponding first answer sheet and store the first assignment and first answer sheet in a database, send the first assignment to a first user device and the first answer sheet to a second user device, receive a first assignment response from the first user device, automatically evaluate the first assignment response received from the first user device based on the first answer sheet, determine a grade for the first assignment response and sending the determined grade to the first user device.

### FIELD OF INVENTION

The present general inventive concept relates to systems and methods of providing an online virtual classroom. The present general inventive concept also provides a synchronized learning management system that automates all aspects of an online classroom.

### BACKGROUND

Over the past several years, technology has improved and expanded traditional education by providing access to online classrooms. However, although online classrooms are accessible 24 hours a day, there currently exists a time delay to receive responses from instructors to students questions. That is, there is always a time lapse between an instructors response or feedback to a student's question or work assignment, which often impedes the progress of students' learning. As a result, the lapse in time for a student to receive constructive feedback remains to be an ongoing issue for conventional online classrooms.

Therefore, what is needed is an interactive learning system that facilitates and automates all aspects of an online classroom, including but not limited to providing immediate feedback to students' questions, discussion postings, and work assignments.

### SUMMARY OF THE INVENTION

The present general inventive concept provides a synchronized learning management system.

The automated learning management system also provides an online virtual classroom that minimizes human error and inefficiencies due to asynchronized communication between instructors and students.

The automated learning management system also provides a completely automated online classroom which may be programmed to automatically send answers to questions received from students in real-time, automatically respond to discussions, automatically grade assignments upon submittal, as well as send announcements and notifications to students.

The present general inventive concept also provides an interactive learning system that facilitates all aspects of an online classroom, including but not limited to providing immediate feedback to students' questions, discussion postings, and work assignments.

The present general inventive concept also provides an interactive learning system that facilitates all aspects of an online classroom, including but not limited to providing immediate feedback to students' questions, discussion postings, and work assignments.

The foregoing and/or other aspects of the present general inventive concept may be achieved by providing an automated online classroom system which includes a processor, a memory on which are stored machine readable instructions that when executed by the processor, cause the processor to: obtain a first assignment and a corresponding first answer sheet and store the first assignment and first answer sheet in a database, send the first assignment to a first user device and the first answer sheet to a second user device, receive a first assignment response from the first user device, automatically evaluate the first assignment response received from the first user device based on the first answer sheet, determine a grade for the first assignment response, and sending the determined grade to the first user device.

The instructions may further cause the processor to generate and send feedback to the first user based on keywords within the received first assignment response.

The processor may evaluate the first assignment response using a grading rubic. The processor may evaluate the first assignment response using autoscans.

The processor may automatically send communications from the second user device to the first user device.

The communication may include an announcement, a discussion response, and an email response.

The communication may be sent based on a subject matter of the communication.

The communication may include business, management, marketing, accounting, and economics. The instructions may further cause the processor to display a hologram image of a second user to a first user through the first user device.

The foregoing and/or other aspects of the present general inventive concept may be achieved by providing a method for providing a synchronized learning assignment system to automate an asynchronous online classroom, the method includes obtaining a first assignment and a corresponding first answer set, sending the first assignment to a first user and the first answer set to a second user, receiving a first response to the first assignment from the second user, automatically using a processor to compare the first response from the second user with the first answer set, and evaluating the first response to determine a grade using the processor based on the first answer set.

Additional aspects of the present general inventive concept will be set forth in part in the description which follows and, in part, will be obvious from the description, or may be learned by practice of the general inventive concept.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a schematic block diagram of a synchronized learning management system having an interactive learning application stored on a computer readable medium (RAM), according to the present general inventive concept;

FIG. 2 is a flow chart illustrating a method for providing synchronized learning management according to an exemplary embodiment of the present general inventive concept;

FIG. 3 is a schematic diagram illustrating an implementation of the synchronized learning management system in FIG. 1, according to an exemplary embodiment of the present general inventive concept;

FIG. 4 is a schematic diagram illustrating an Auto Response Announcement operation of the synchronized learning management system in FIG. 1;

FIG. 5 is a schematic diagram illustrating an Auto Response Discussions operation of the synchronized learning management system in FIG. 1;

FIGS. 6A-B are schematic diagrams illustrating a Weekly System Auto Response Schedule operation of the synchronized learning management system in FIG. 1;

FIG. 7 is a schematic diagram illustrating an Auto Response Question and Answer (Q&A bank) operation of the synchronized learning management system in FIG. 1; and

FIG. 8 is a schematic diagram illustrating an Auto Response Grading-Scan/Grade/Feedback.

### DETAILED DESCRIPTION OF THE INVENTION

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

The present general inventive concept provides a system utilizing a software application which is used to execute a method of providing a completely automated online classroom.

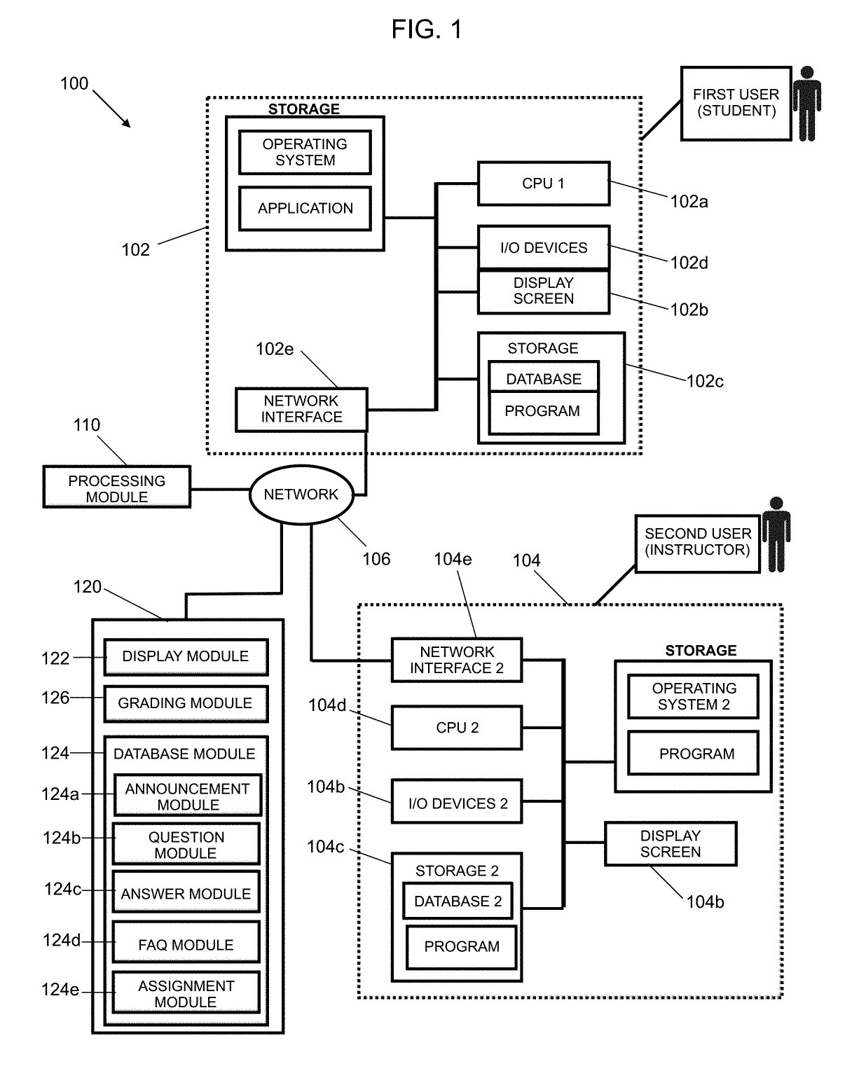

FIG. 1 is a schematic block diagram of a synchronized learning management system 100 according to an exemplary embodiment of the present general inventive concept. The system 100 includes a first user device 102 that is used by a student, a second user device 104 that is used by an instructor, a system processing module 110 and a synchronized learning management platform 120 that are all in communication with the first and second user device 102, 104 through a network 106. However, the present general inventive concept is not limited thereto. That is, in alternative embodiments, the synchronized learning management system 100 according to the present general inventive concept may be used with a plurality of first user devices used by a plurality of students and a plurality of second user devices used by a plurality of instructors.

In the present embodiment, the first user device 102 includes a controller (CPU) 102a, a display screen 102b, a storage device 102c, input/output devices 102d, and a network interface 102e to communicate to external devices via the network 106. Similarly, the second user device 104 includes a controller (CPU) 104a, a display screen 104b, a storage device 104c, input/output devices 104d, and a network interface 104e to communicate to external devices via the network 106.

In alternative exemplary embodiments, the first and second user devices 102, 104 may be implemented by a plurality of electronic communication devices including computers, laptops, telephones, personal digital assistant, and/or various other types of wired and/or wireless computing devices.

In the present embodiment, the network 106 may be implemented as a single network or may include a plurality of networks, including the Internet, wireless networks, and/or various other communication networks.

The synchronized learning management system 100 includes the system processing module 110 which is used to receive data and instructions, process, and then output specific communications, data, and/or instructions based on the received data. The processing module 110 may include a plurality of servers, each having a plurality of custom designed processors to function with the management system 100.

In exemplary embodiments, the first and second user devices 102, 104 may include a user interface application comprising a software program that is stored within the data storage device and executed by the CPU. The user interface application may include a graphical user interface (GUI), executable by the CPU or processor within the first and second user devices 102, 104 in order to allow the first and second user to communicate and send/receive data via the network 106.

The synchronized learning management system 100 functions based on keywords and/or algorithms which focus on specific high-touch areas within an online classroom. For example, the synchronized learning management system 100 addresses (1) online classroom discussions; (2) announcements; (3) question and answers between first users (i.e., students) and second users (i.e., instructors or facilitators); and (4) grading.

The synchronized learning management platform 120 includes a display module 122, a database module 124 which includes an announcement module 124a, a question module 124b, an answer module 124c, a FAQ module 124d, and an assignment module 126e, and a grading module 126. The display module 122 is configured to process data in such a manner so as to be displayed on the display screens 102b, 104b. The database module 124 is configured to process data handled by the various modules.

In the present embodiment, the automated online classroom system 100 includes a processing module 110 (i.e., a processor), a memory on which are stored machine readable instructions that when executed by the processing module 110, cause the processing module 100 to obtain a first assignment from the assignment module 124e and a corresponding first answer sheet from the answer module 124c. The processing module 100 is then instructed to store the first assignment and the corresponding first answer sheet within the database module 124.

The assignment module 124e is configured to send the first assignment to a first user device 102 through a network 106 and the answer module 124c is configured to send a corresponding first answer sheet to a second user device 104.

The answer module 124c is configured to receive a first assignment response from the first user device 102 through the network.

The grading module 126 is configured to automatically evaluate the first assignment response received from the first user device 102 based on the first answer sheet, immediately upon receipt of the first assignment response from the first user device 102. The grading module 126 then determines a grade for the first assignment response and sends the determined grade to the first user device 102.

In exemplary embodiments, the instructions are further to cause the processing module 110 to generate and send feedback to the first user device 102 based on keywords within the received first assignment response.

In exemplary embodiments, a processor within the grading module 126 evaluates and grades the first assignment response based on a grading rubic and/or autoscans.

In exemplary embodiments, the processing module 110 automatically sends communications, including announcements stored within the announcement module 124a, discussions, FAQ stored within the FAQ module 124d, and email responses to the first user device 102. The communication may be sent based on a subject matter of the communication including business, management, marketing, accounting, and economics.

In alternative exemplary embodiments, the instructions are further to cause the display module 122 to generate and display a hologram image of the second user to the second user.

In exemplary embodiments, the synchronized learning management system 100 is designed and/or configured to include a system of automation, wherein the capability of each module is achieved through the use of automation capability as a niche-market response to the disconnect currently experienced between online instructors, facilitators, teaching assistants, and online students (e.g., learners).

The synchronized learning management system 100 functions to eliminate or substantially reduce the waiting period between the first user (i.e., student) and the second user (i.e., instructor or facilitator) and provides instant and automatic feedback to the first users questions, in real-time, to improve and quicken the first users ability to learn.

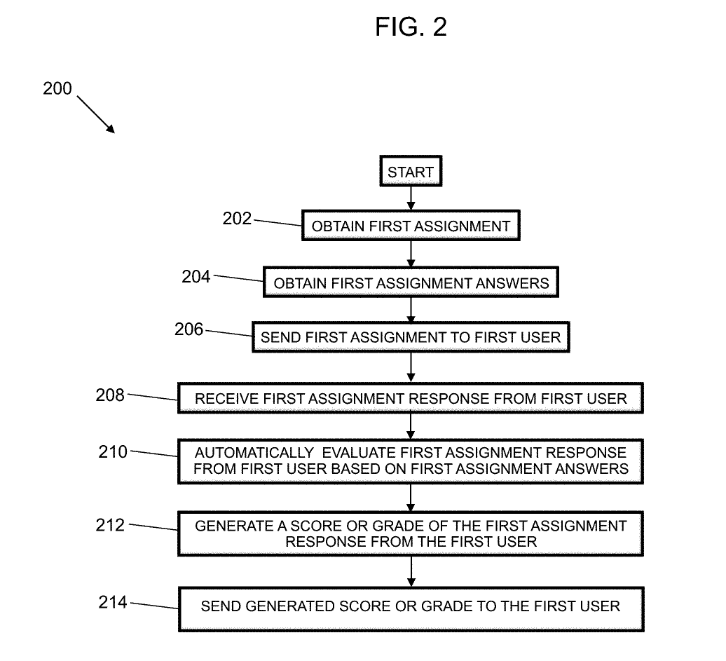

FIG. 2 is a flow chart illustrating a method 200 for providing synchronized learning management according to an exemplary embodiment of the present general inventive concept.

At step 202, the synchronized learning management system 100 obtains a first assignment through a plurality of sources including instructors or through an external database.

At step 204, the system 100 obtains first assignment answers corresponding to questions within the first assignment.

At step 206, the system 100 sends the first assignment to a first user using a first user device 102 and the first assignment answers to a second user using a second user device 104.

At step 208, the system 100 receives a first assignment response from the first user through the first user device 102 and a network 106.

At step 210, the system 100 immediately and automatically evaluates the first assignment response from the first user based on the first assignment answers. The system 100 then, at step 212, generates a score or grade for the first assignment response from the first user device 102 and sends the score or grade to the first user through the first user device 102 (step 214).

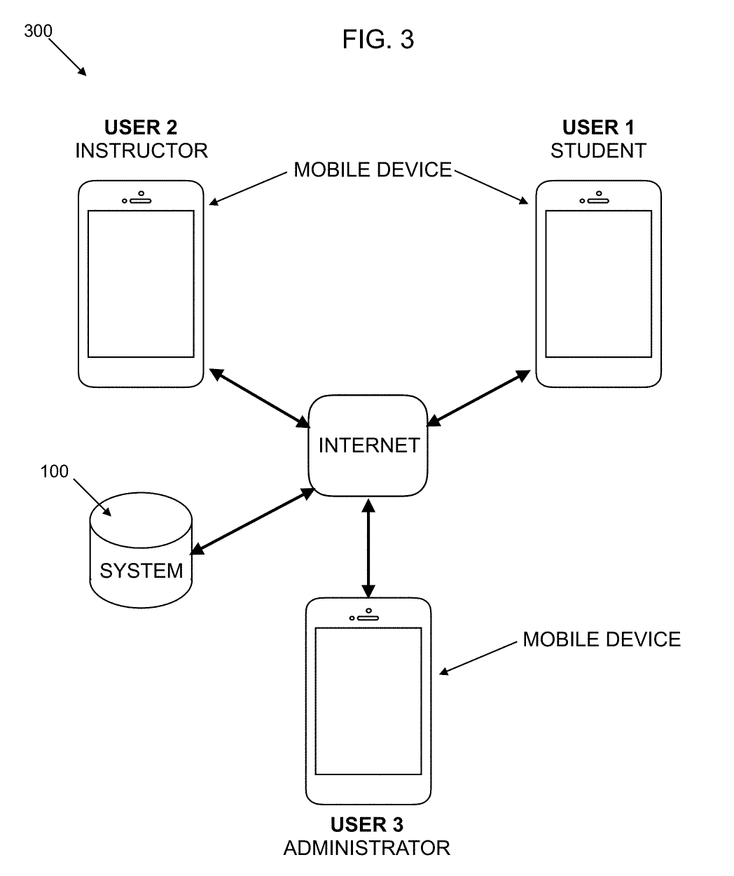

FIG. 3 is a schematic diagram illustrating an implementation of the synchronized learning management system 200 in FIG. 1, according to another exemplary embodiment of the present general inventive concept.

In alternative exemplary embodiments, the synchronized learning management system 100 utilizes software that is compatible with and improves the functionality of currently available learning management systems (LMS). For instance, the synchronized learning management system 100 utilizes software that is compatible with ANGEL, Adobe Connect, Blackboard 9.2, Blackboard Ultra Collaborate, Canvas, CourseNet, Desire-To-Learn D2L, eCollege, Horizon Wimba, Macromedia Breeze, Moodie, Pronto Live, Sakai, University Alliance, and WebCT. However, the present general inventive concept is not limited thereto.

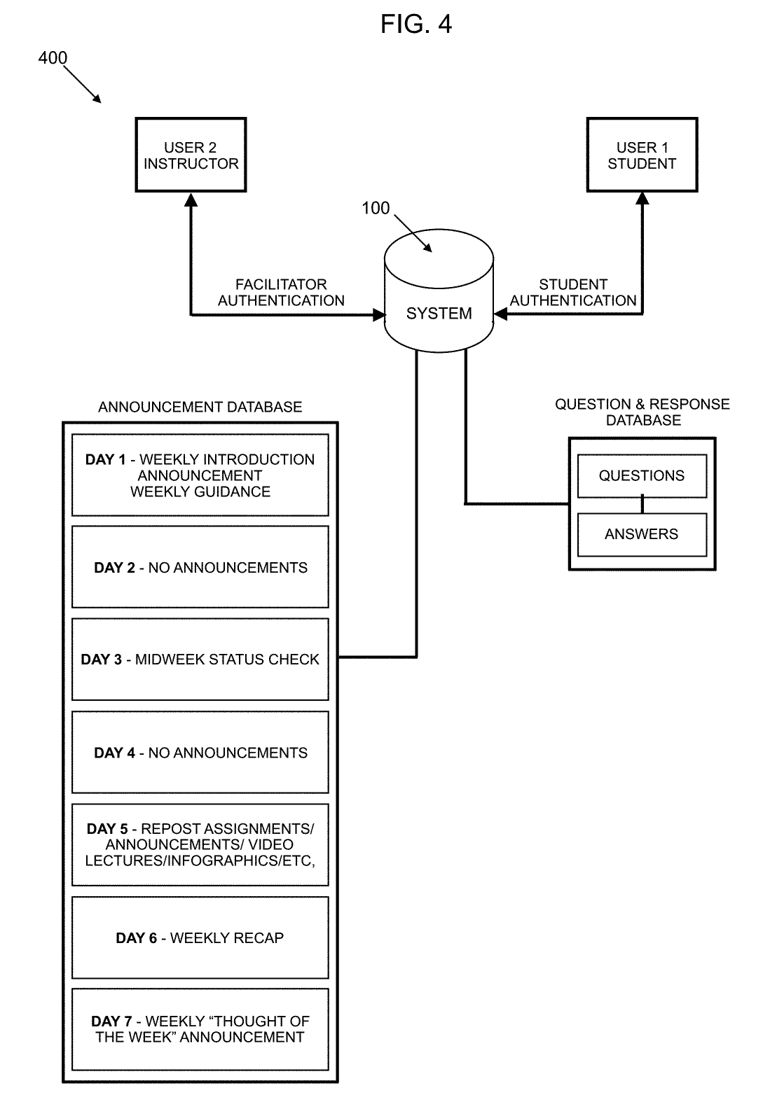

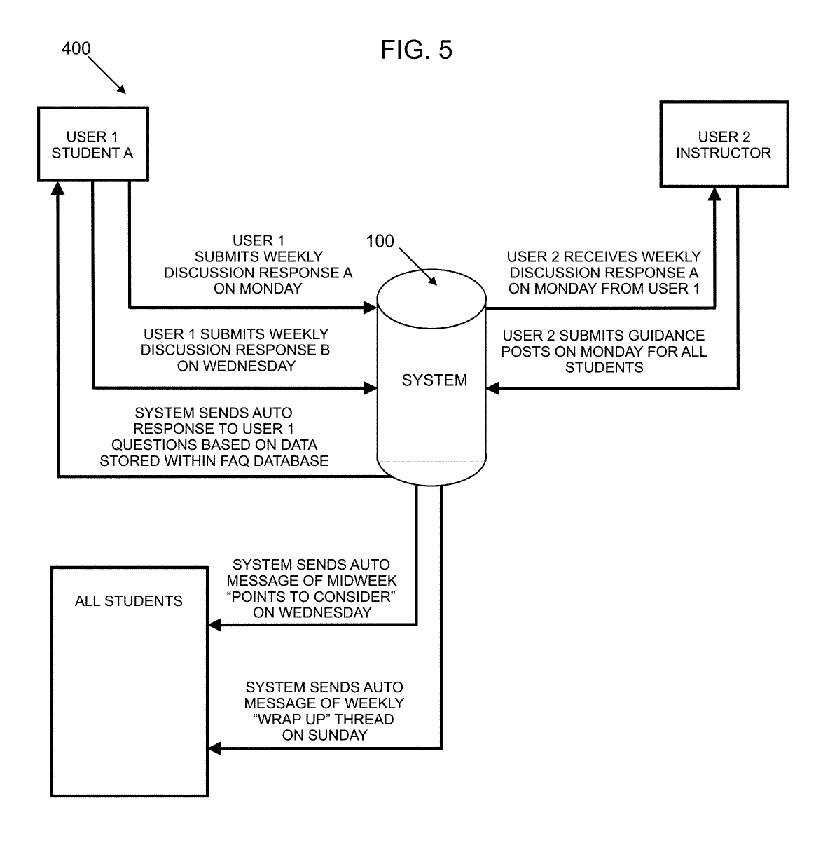

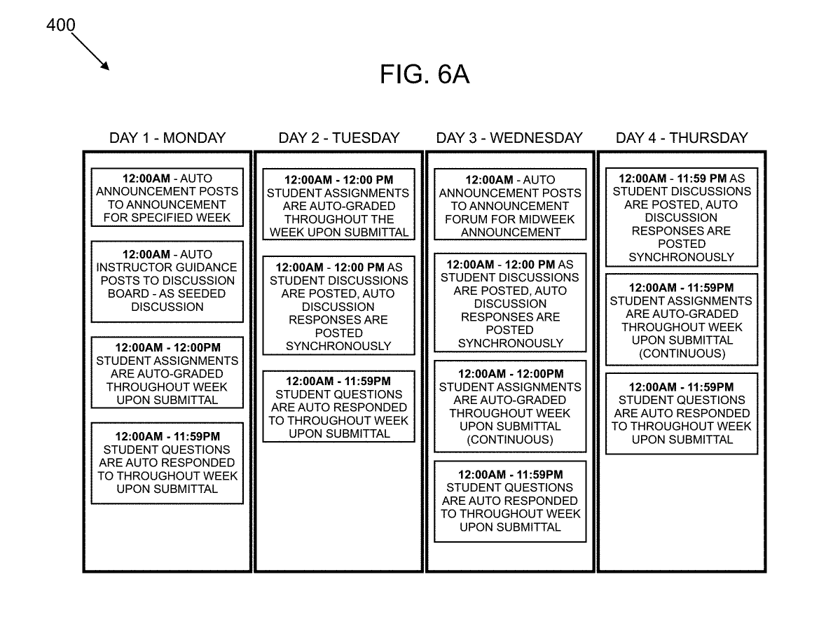

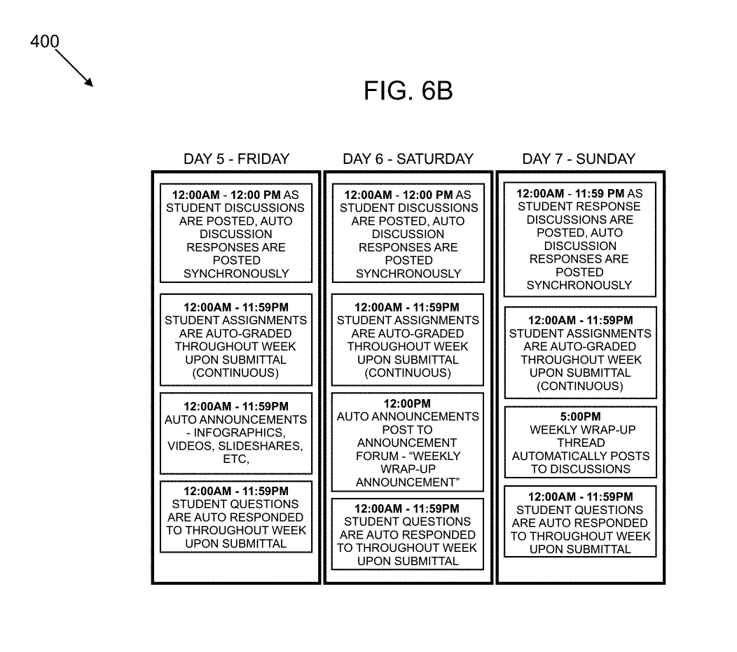

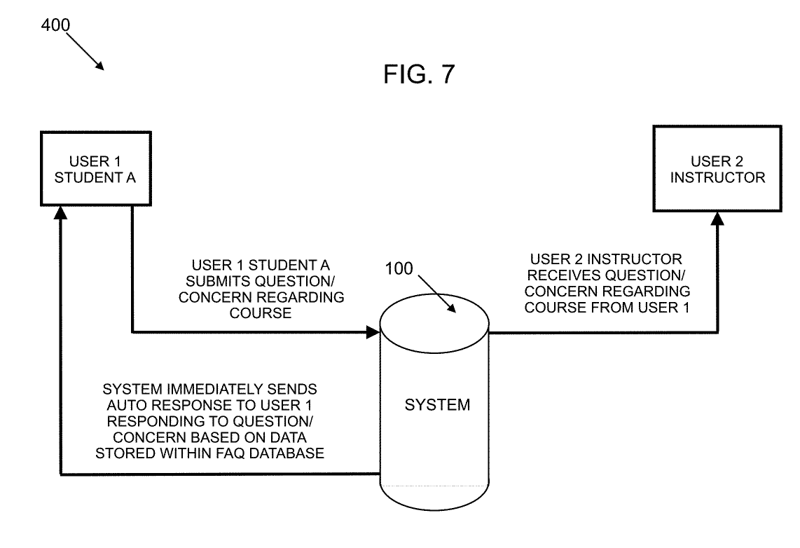

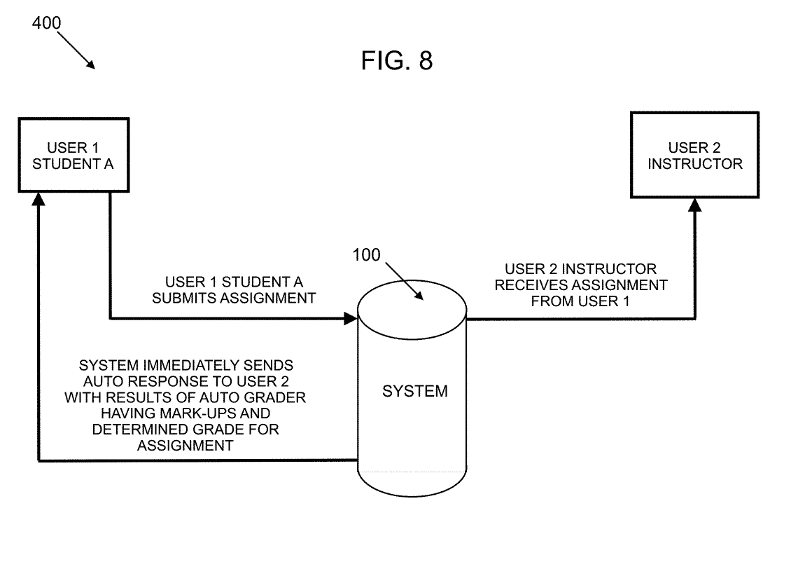

FIG. 4 is a schematic diagram illustrating an Auto Response Discussions operation of the synchronized learning management system 100 in FIG. 1. FIGS. 6A-B are schematic diagrams illustrating a Weekly System Auto Response Schedule operation of the synchronized learning management system 100 in FIG. 1. FIG. 7 is a schematic diagram illustrating an Auto Response Question and Answer (Q&A bank) operation of the synchronized learning management system 100 in FIG. 1. FIG. 8 is a schematic diagram illustrating an Auto Response Grading—Scan/Grade/Feedback.

The present general inventive concept provides a synchronized learning management system that eliminates the time delay between students and instructors in online classrooms. The system is usable with a plurality of devices including a smart phone, tablet, computer or other mobile device.

The present general inventive concept also provides a synchronized learning management system that includes a software program (e.g., Adjutech Software) that seeks to address the lapse of time between facilitators feedback and response time to learners by providing a 100% automated online classroom. The system uses keywords and algorithms to allow the online learners to receive instant personalized discussion responses from the facilitator (e.g., topic generated feedback), multiple auto-announcements throughout each week, immediate personalized, highly detailed grading feedback (suggestions for improvements) based on grading algorithms, and instant response to questions posted by students.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description but is only limited by the scope of the appended claims.

What is claimed is:

1. An automated online classroom system comprising:
a processor;
a memory on which are stored machine readable instructions that when executed by the processor, cause the processor to:
obtain a first assignment and a corresponding first answer sheet and store the first assignment and first answer sheet in a database;
send the first assignment to a first user device and the first answer sheet to a second user device;
receive a first assignment response from the first user device;
automatically evaluate the first assignment response received from the first user device based on the first answer sheet;
determine a grade for the first assignment response; and
sending the determined grade to the first user device.

2. The automated online classroom system of claim 1, wherein the instructions are further to cause the processor to generate and send feedback to the first user device based on keywords within the received first assignment response.

3. The automated online classroom system of claim 1, wherein the processor evaluates the first assignment response using a grading rubic.

4. The automated online classroom system of claim 1, wherein the processor evaluates the first assignment response using autoscans.

5. The automated online classroom system of claim 1, wherein the processor automatically sends communication from the second user device to the first user device.

6. The automated online classroom system of claim 5, wherein the communication includes an announcement, a discussion response, and an email response.

7. The automated online classroom system of claim 5, wherein the communication is sent based on a subject matter of the communication.

8. The automated online classroom system of claim 7, wherein the communication includes business, management, marketing, accounting, and economics.

9. The automated online classroom system of claim 1, wherein the instructions are further to cause the processor to display a hologram image of the second user to the first user.

10. A method for providing a synchronized learning assignment system to automate an asynchronous online classroom, the method comprising:
obtaining a first assignment and a corresponding first answer set;
sending the first assignment to a first user device and the first answer set to a second user device;
receiving a first response to the first assignment from the first user device;
automatically using a processor to compare the first response from the first user device with the first answer set; and
evaluating the first response to determine a grade using the processor based on the first answer set.

11. The method of claim 10, further comprising automatically sending the grade to the second user immediately after being determined by the processor.

12. The method of claim 11, wherein the evaluating the first response includes evaluating key words within the first response.

13. The method of claim 11, wherein the evaluating the first response includes evaluating the first response using a grading rubric.

14. The method of claim 11, wherein the evaluating the first response includes evaluating the first response using autoscans.

15. The method of claim 10, further comprising sending an automated communication from the second user device to the first user device.

16. The method of claim 15, the automated communication includes an announcement, a discussion response, and an email response.

17. The method of claim 15, the automated communication is sent based on a pre-defined schedule.

18. The method of claim 15, the automated communication is sent based on a subject matter of the automated communication.

19. The method of claim 17, the subject matter of the automated communication includes business, management, marketing, accounting, and economics.

20. The method of claim 10, further comprising displaying a hologram Image of a second user to a first user through the first user device.
